(19) United States
(12) Patent Application Publication
(10) Pub. No.: US 2022/0343715 A1
(43) Pub. Date: Oct. 27, 2022

(54) VEHICLE KEY PROGRAMMING MOBILE ASSIST SYSTEM AND METHOD

(71) Applicant: HY-KO PRODUCTS COMPANY LLC, Portage, MI (US)

(72) Inventors: William R. Mutch, North Ridgeville, OH (US); Michael A. Bass, Beachwood, OH (US); Justin A. Gill, Olmsted Township, OH (US); Randall A. Porras, Avon, OH (US); Ernest J. Mantkowski, Macedonia, OH (US); Ann M. Ross, Fairview Park, OH (US); Petro S. Spurrier, Wadsworth, OH (US)

(21) Appl. No.: 17/727,181

(22) Filed: Apr. 22, 2022

Related U.S. Application Data
(60) Provisional application No. 63/178,080, filed on Apr. 22, 2021.

(51) Int. Cl. G07F 11/70; G07F 17/26

(52) U.S. Cl. CPC G07F 11/70; G07F 17/26

(57) ABSTRACT

This disclosure relates to a system for providing assistance when operating a key duplicating machine or when programming a new vehicle key. An application operating on a mobile device receives information regarding the vehicle and key application and will then assists the user while programming the key associated with the vehicle. In some examples, a key duplicating machine receives input from the user and passes data to the application in order to provide better and more specific assistance.

### CROSS-REFERENCE TO RELATED APPLICATIONS

This application claims priority to and the benefit of U.S. Provisional Patent Application No. 63/178,080 filed on Apr. 22, 2021 and titled, “VEHICLE KEY PROGRAMMING MOBILE ASSIST SYSTEM AND METHOD” which is incorporated by reference herein in its entirety.

### TECHNICAL FIELD

The present invention is generally related to devices for programming vehicle keys and, more specifically, digital assistance for operating such a device. This application is related to applicant's commonly owned patents including: U.S. Pat. Nos. 7,891,919; 7,890,878; 8,634,655; 8,644,619; 9,101,990; 9,308,590; 9,963,908; and U.S. Published Application Nos. 2018/0307825 and 2019/0287332, each of which are incorporated by reference in their entireties.

### BACKGROUND

Programming vehicle keys often involves complex processes that must be followed precisely to be successful. Some aftermarket transponder key duplicating processes require collecting data from the vehicle. And, On Board Diagnostic (OBD) programming tool processes that can also be used to program new keys for a vehicle are typically even more complicated. Each manufacturer uses different programming methods and each has changed the methods over the years. As such, there are dozens of varying programming routines with different types of steps and different requirements depending on the vehicle make, model, year and key type. Because it is so complicated, the process has typically been done by only vehicle dealership technicians and experienced automotive locksmiths. In addition, the process of testing both cloned transponder keys and OBD programmed vehicle keys can also be confusing and, if not done properly, can lead to a temporarily disabled vehicle.

There is a need, however, in the retail store industry, to supply such duplicate keys to consumers. The challenge is that retail store associates will never do enough vehicles to become proficient in the dozens of different programming processes. This especially true since the typical OBD key programming tools on the market are designed for the experienced dealership technician and/or automotive locksmith user. As such, a user friendly mobile assistant tool would be of great benefit to such retail store associates in order to help them successfully program and test keys in the vehicle. A vehicle key programming mobile assistant tool would need to provide the guidance and knowledge of the experienced locksmith in a cost effective format that can be easily understood and followed by the store associate.

Some traditional key cutting devices may reduce errors that occur when store employees oversee the process of key duplication. Some of these devices may even allow store customers to oversee the process of key duplication. Store employees and customers may each require different amounts of information or guidance when replicating keys. Machines may thus provide an employee too much information or provide customers with too little information.

### SUMMARY

A system for providing assistance when operating a key duplicating machine and/or programming a vehicle key is provided. An application operating on a mobile device receives information from the key duplicating machine in order to assist the user operating the key duplicating machine, as well as when programming and/or testing a new vehicle key. In some examples, the key duplicating machine receives input from the user (sometimes referred to as “machine input data”) (e.g., year, make, and/or model of the vehicle, and/or key type, etc.) in the process of duplicating a key. When assistance is available, the key duplicating machine generates a code (e.g., a bar code, an identifier, a QR code, etc.) that communicates or provides the machine input data to the application operating on the mobile device either directly or indirectly using communications app, such as a mobile device's camera or QR code scanning app. The application provides general assistance for using the key duplicating machine as well as programming new vehicle keys and specific assistance based on the machine input data. For example, the features provided by the user may be customized by the input data. The application may provide steps and/or a questionnaire to guide the user. Inputs that result from these steps and/or a questionnaire are stored (sometimes referred to as “application input data”). Further, when the user indicates that they need further assistance (e.g., via a live operator, etc.), the application may communicate the machine input data and the application input data to a server to customized and/or prepopulate the information. This facilitates a user getting customized assistance while operating a key duplicating machine as well as for programming a new vehicle key while eliminating frustration of escalation of assistance without context of what the user has input into the system.

An example system includes a key duplication machine and an application operating on a mobile device. The key duplication machine duplicates keys. The key duplication machine displays an indicia unique to the key duplication process at hand. The application captures the indicia, and presents graphical interfaces to provide step-by-step instructions to operate the key duplication machine as well as programming a new vehicle key. In some examples, the system includes a support client operating on a computing device. The support client presents a tech support interface to facilitate helping a user of the app operate the key duplication machine as well as for programming a new vehicle key.

An example method includes, in response to an input, displaying, on a key duplication machine configured to duplicate a master key, an indicia unique to the key duplication machine. The method also includes capturing, on an app operating on a mobile device, the indicia. Additionally, the method includes presenting, on the app, graphical interfaces to provide step-by-step instructions to operate the key duplication machine as well as for programming a new vehicle key.

### BRIEF DESCRIPTION OF THE DRAWINGS

Operation of the present disclosure may be better understood by reference to the following detailed description taken in connection with the following illustrations, wherein:

FIG. 1 illustrates a conceptual diagram of the system to provide assistance to a user, in accordance with the teachings of this disclosure.

FIGS. 2A-2J illustrate example graphical interfaces for an application to provide assistance to a user, in accordance with the teachings of this disclosure.

FIGS. 3A and 3B illustrates an example of a communication interface where an assistance program may provide a communication link to a technical support specialist for additional help, in accordance with the teachings of this disclosure.

FIG. 4 illustrates a type of vehicle key that may require programming or duplication according to the teachings of this disclosure

### DETAILED DESCRIPTION

Reference will now be made in detail to exemplary embodiments of the present disclosure, examples of which are illustrated in the accompanying drawings. It is to be understood that other embodiments may be utilized and structural and functional changes may be made without departing from the respective scope of the present disclosure. Moreover, features of the various embodiments may be combined or altered without departing from the scope of the present disclosure. As such, the following description is presented by way of illustration only and should not limit in any way the various alternatives and modifications that may be made to the illustrated embodiments and still be within the spirit and scope of the present disclosure.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

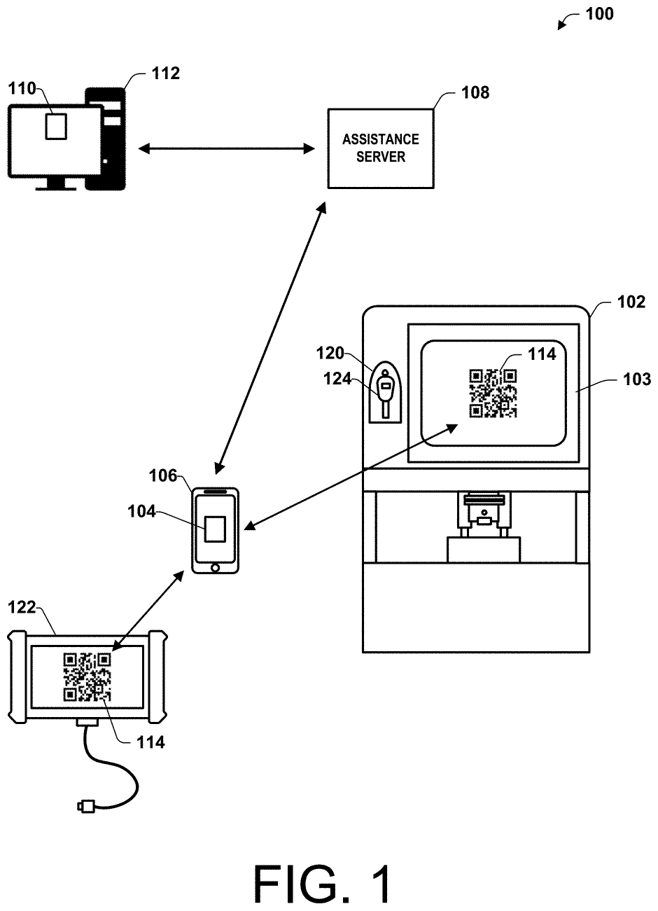

FIG. 1 illustrates a system 100 to provide assistance to a user for operating a key duplication machine 102 or to provide assistance to a user when programming a new vehicle key 124. In the illustrated example, the system 100 includes the key duplication machine 102 and application 104 operating on a mobile device 106 (e.g., a smart phone, a smart watch, a tablet, etc.), an assistance server 108, and a tech support application 110 operating on a computing device 112 (e.g., a desktop computer, a laptop computer, a workstation, etc.). The application 104 may be a dedicated application (sometimes referred to as an “app”) or may be an application executing inside of another application (such as a web browser, etc.). The application 104 is intended to assist a store associate when programming a new vehicle key 124 using a processor tool 120 which may be considered a cloning tool or OBD key programming tool 122. Such a processing tool 120 or OBD key programming tool 122 is disclosed in U.S. Published Application Nos. 2018/0307825 and 2019/0287332 which are incorporated by reference in their entireties. In the illustrated example, the processing tool 120 to duplicate the key is incorporated into the key duplication machine 102.

The key duplication machine 102 is configured to duplicate a master key 124. The example key duplication machine 102 captures an optical image of a profile or silhouette of the master key, including the key pattern of the master key, and the capture of a profile or silhouette of a key blank. The captured images are analyzed to determine the proper key blank to be used for a duplicate key, validate the selection of the proper key blank, facilitate the accurate cutting of the key pattern of the master key into the key blank, and validate the accuracy of the key pattern cut into the key blank. The key duplication machine 102 cuts variety of key types, such as single-sided keys, double-sided keys, sidewinder keys, house keys, automobile keys, commercial keys, and the like. It should be appreciated that the key duplication machine 102 could be any type of key duplicating machine.

In the illustrated example, the key duplication machine 102 includes a screen 103 with a duplication interface. The duplication interface facilitated receiving input to duplicate the master key and receive input from the user. The input from the user and the result of the analysis is machine input data. The machine input data may include, for example, store type, store number, base key name, media codes, testing ID, troubleshooting ID, vehicle make, vehicle model, vehicle year, and/or language of the interface of the key duplication machine 102. After its analysis is complete, the key duplication machine 102 may display indicia 114 (e.g., a bar code, a QR code, an alphanumeric code, etc.) that incorporates and/or codes the machine input data such that the application 104 may receive the machine input data via visual input (e.g., via a camera, etc.). It should be appreciated that indicia 114 is just one example of a method for passing the machine input data to the application 104 and this invention is not limited to this one example. Any number of methods could be used to pass the needed data to the application 104 including manually entering or manually selecting the data on application 104, having a multitude of printed indicia 114 available to scan, passing a displaying and manually entering a coded message that is linked to the data, etc.

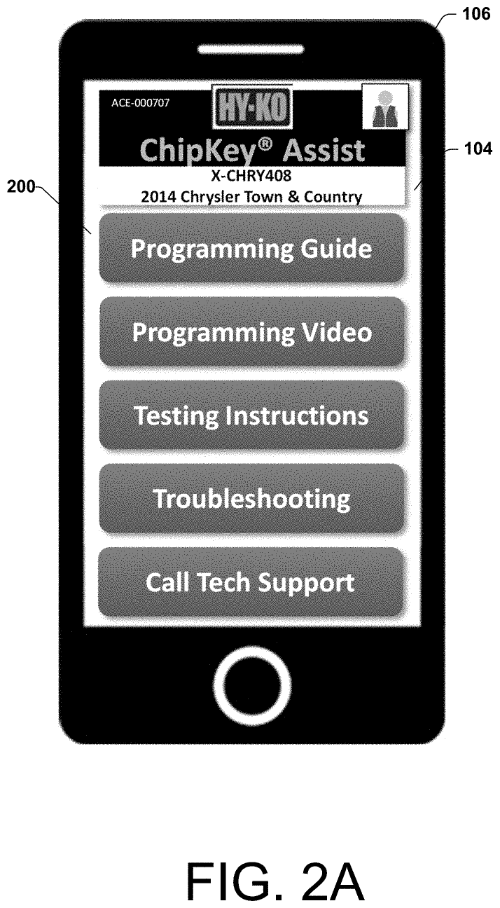

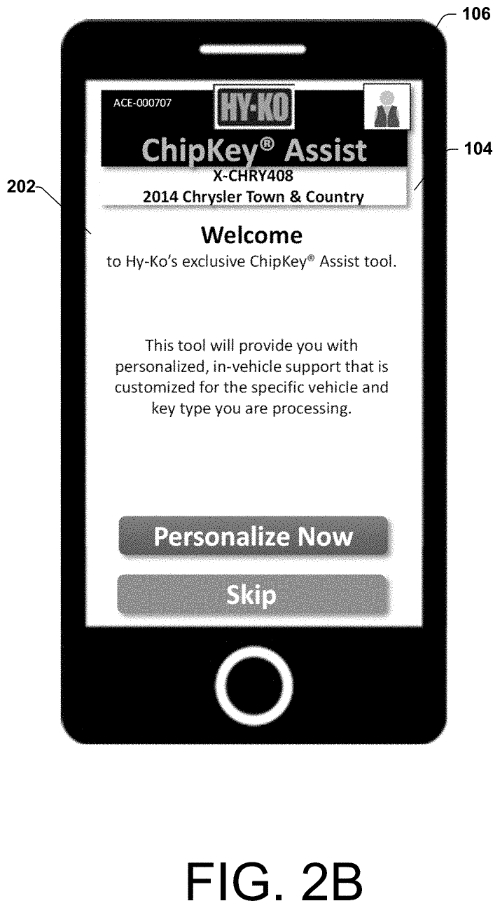

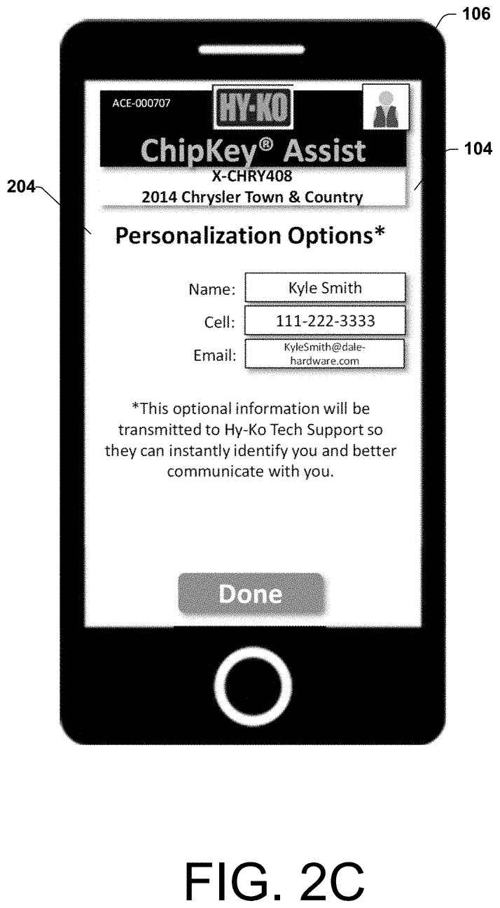

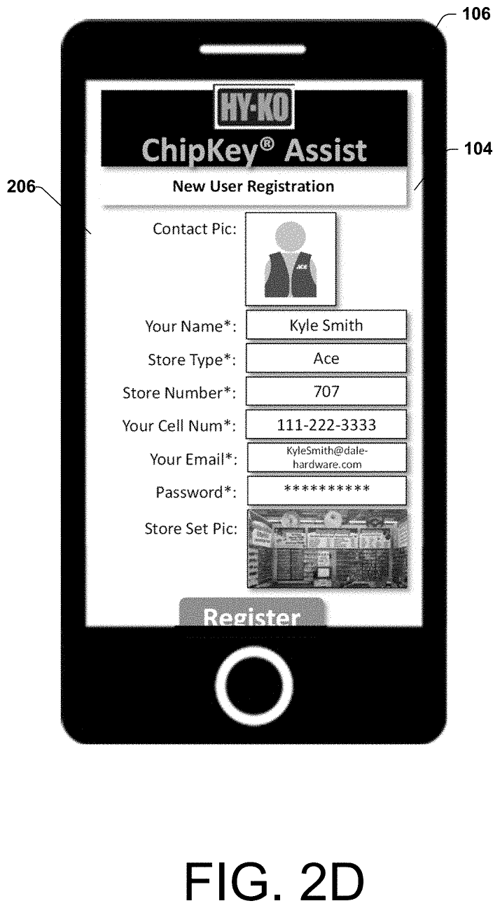

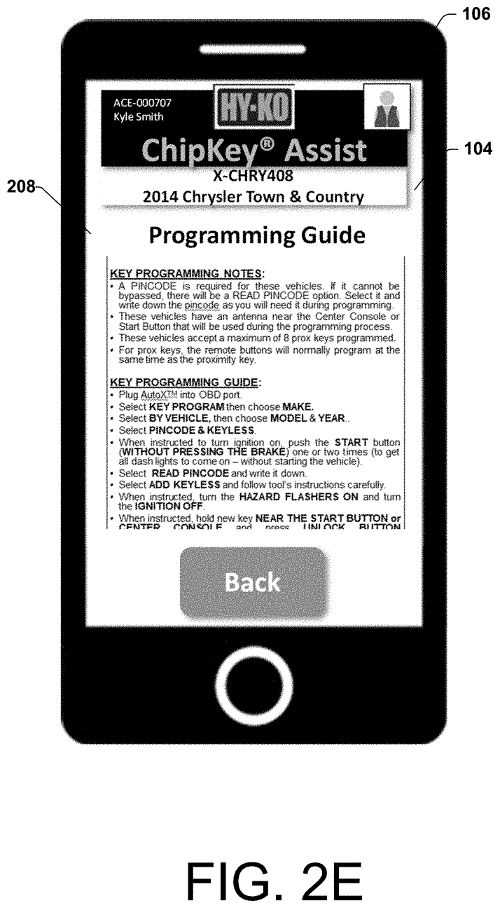

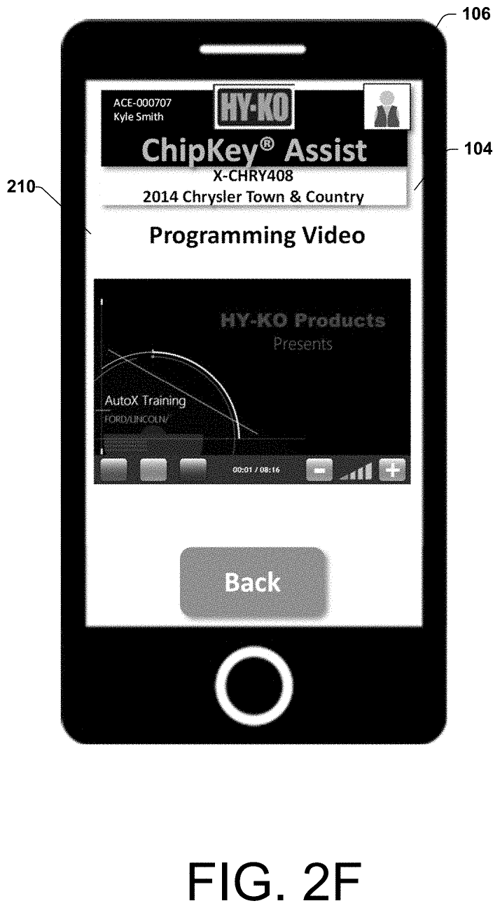

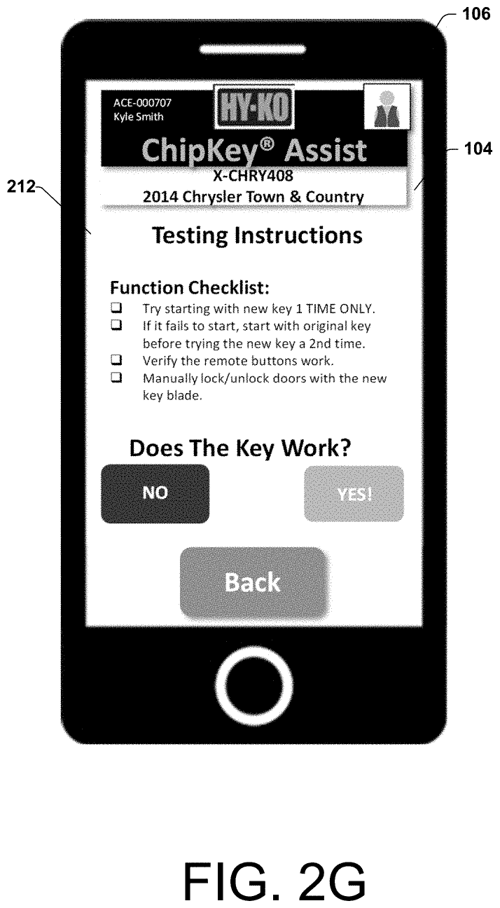

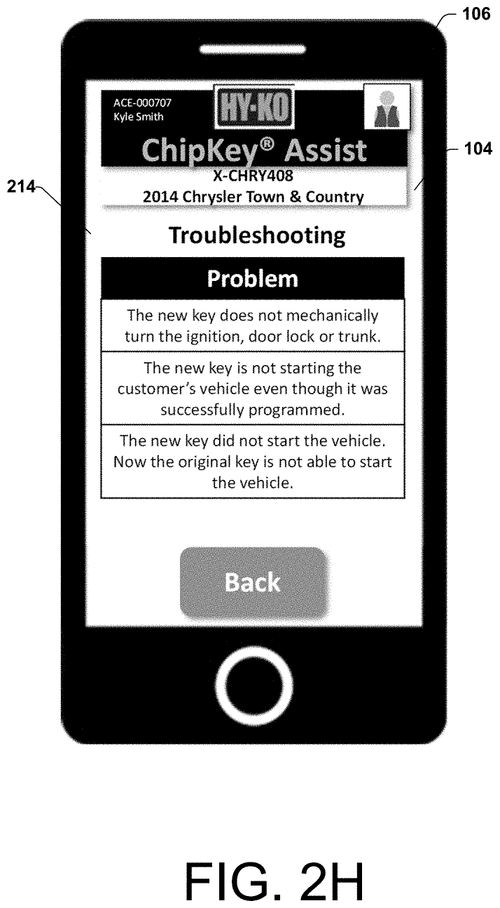

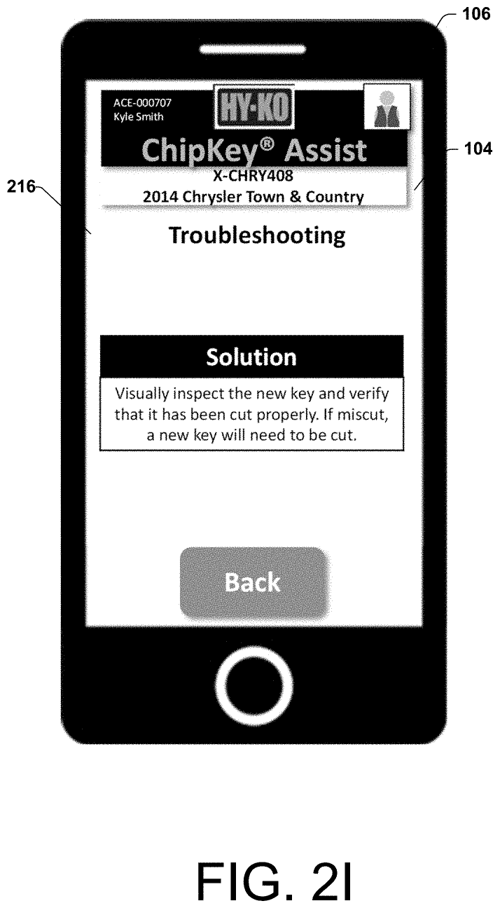

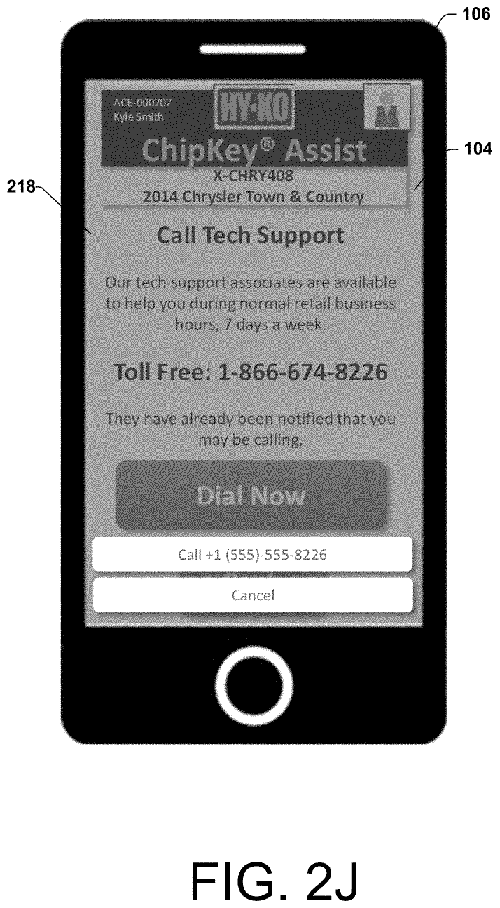

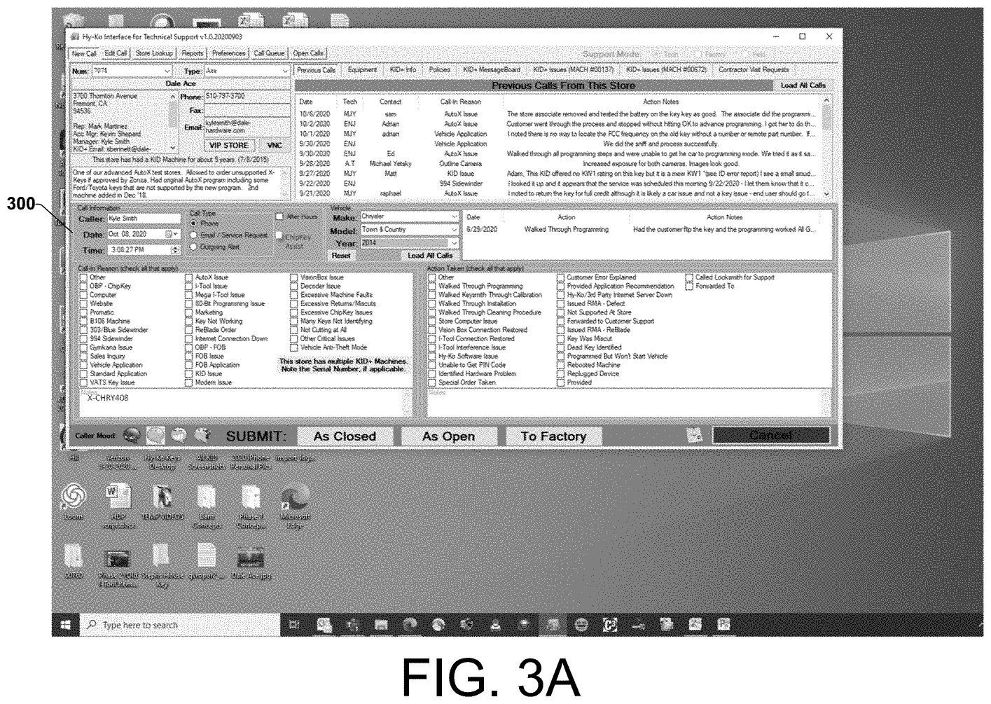

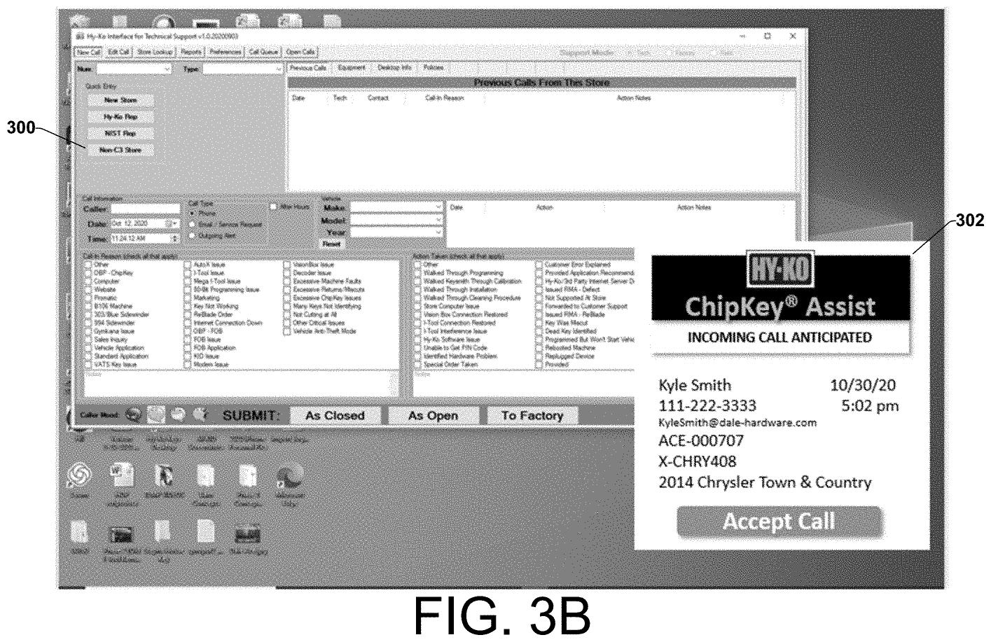

As described below in FIGS. 2A-2J, the application 104 provides a series of graphical interfaces to provide assistance to the user and receive application input data generated, in part, as the user proceeds through the assistance graphical interfaces. The application could have all of the data for the assistance interfaces store locally or could be retrieving the data from the assistance server 108. When the application 104 initiates or otherwise facilitates the user connecting to live tech support resources, the machine input data and the application input data is forwarded to the assistance server 108. The assistance server 108 then provides the machine input data and the application input data to the tech support application 110 (as illustrated in FIGS. 3A and 3B).

FIGS. 2A-2J illustrate example graphical interfaces 200-218 for the application 104 to provide assistance to a user. FIG. 2A illustrates an example menu graphical interfaces 200 that provides a navigational guide to the assistance functions of the application 104. In some examples, the menu graphical interfaces 200 is customized based on the input data and application programming interface (API) calls to populate the menu graphical interfaces 200 based on the input data.

FIG. 2B illustrates an example first personalize graphical interfaces 202 that acts as a welcome screen to further personalize the assistance. The first personalize graphical interfaces 202 receives input of some application data (e.g., name, contact information, etc.) to that facilitates personalization of any subsequent live assistance. FIGS. 2C and 2D illustrate example second and third personalize graphical interfaces 204 and 206 to receive input of some of the application data to that facilitates personalization of any subsequent live assistance. As illustrated in FIG. 2D, the user may use the third personalize graphical interfaces 206 to register an account that saves the personalized information.

FIG. 2E illustrates an example programming guide interface 208 to supply the user with a guide for programming a new vehicle key 124 using an OBD key programming tool 122. The content may be supplied by the assistance server 108. In some examples, the content is customized based on the input data. For example, the programming guide for the specific key indicated by the input data. FIG. 2F illustrates an example multimedia interface 210. The multimedia interface 210 provides one or more multimedia presentations (e.g., videos, sound files, animated images, etc.) and may be specific to the key and/or vehicle as indicated by the input data.

FIG. 2G illustrates an example instructions interface 212. The instructions interface 212 provides a step-by-step set of instructions, customized by the machine input data. For example, the testing instructions may be populated via the assistance server 108 based on, for example, the testing ID and information within the machine input data. As the user performs steps, the results are recorded as part of the application input data. In some examples, each result is paired with a timestamp.

FIG. 2H illustrates an example troubleshooting interface 214. The troubleshooting interface 214 may be populated via API calls to the assistance server 108 based on the machine input data. The troubleshooting interface 214 may display a set of pre-determined problem text and, in response to an input indicative of one of the pre-determined problem texts, a suggested solution for the problem (as illustrated in an example solution interface 216 of FIG. 2I).

FIG. 2J illustrates an example tech support interface 218 that provides an interface for the user to contact a live tech support resource. In some examples, in response to making a call through the tech support interface 218, the application input data and the machine input data is provided to the live tech support resource. For example, the provided data may include store type, store number, base key, vehicle year, vehicle make, vehicle model, name of the user, and/or contact information (e.g., mobile number and/or email address, etc.).

FIGS. 3A and 3B illustrate an example tech support interface program 300 provided to the live tech support resource prepopulated with the received application input data and the machine input data. FIG. 3B illustrates a mobile assist popup communication notice 302 that informs the tech support resource of an anticipated incoming call. The call could be any type of audible communication including a voice over IP call on the tech support computer, a video call on the tech support computer, and/or a traditional phone call to a landline or cellular phone. This mobile assist popup communication notice 302 is triggered by the mobile app 104 transmitting a notice through assistance server 108 and could include the application input data. In addition, the mobile assist popup communication notice 302 could pass on the application input data to the tech support interface program 300 so the tech support representative does not have to enter that data manually. The tech support interface program 300 receives data from the application 104 and entered via the graphical interfaces 200-218 such that, when the technical support specialist is connected to the customer over voice, the fields in the mobile assist popup communication notice 302 are prepopulated to facilitate assisting the customer.

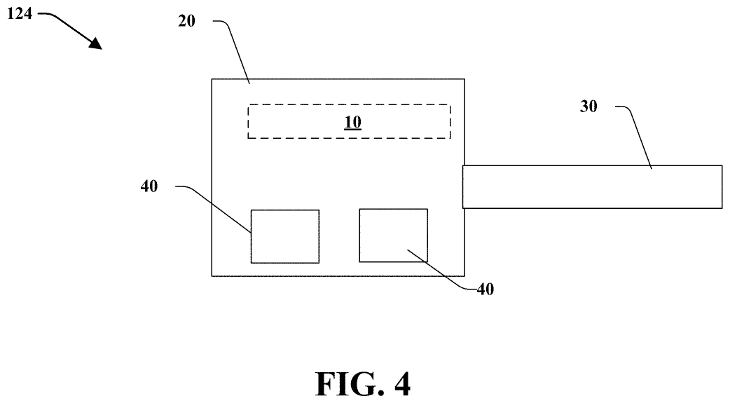

FIG. 4 illustrates a type of vehicle key that may require programming or duplication according to the teachings of this disclosure, for producing a suitable new vehicle key 124 such as an access device/master key to replace or supplement the original ones that came with a vehicle. Vehicles typically include an original key that is a suitable match for the vehicle, commonly referred to as the master key. This typically is the original key that was shipped with the vehicle from the factory or the vehicle's original equipment manufacturer (OEM). These master keys referred to herein include an electronic access device 10 that includes electronic security information and may be such things as a transponder key, an integrated remote head key (IHRK), a Finger Operated Button Integrated Key (FOBIK), a proximity key, a smart phone, a universal remote, and/or any combination thereof. Some master keys 124 also may include a blade 30 having a pattern of bittings and grooves thereon that are patterned to correspond to tumbler members, typically pins or wafers, within an ignition and/or doors of a vehicle. The new vehicle key 124 may include either or both the electronic access device 10 that includes a transponder having the secure information thereon that assists to operate a vehicle and the patterned blade 30 compatible with a particular tumbler member of that vehicle's ignition and/or doors. The housing 20 of the key 124 may also include a plurality of buttons 40 for various operations (i.e., lock, unlock, trunk, alarm, etc.).

Although the embodiments of the present invention have been illustrated in the accompanying drawings and described in the foregoing detailed description, it is to be understood that the present disclosure is not to be limited to just the embodiments disclosed, but that the disclosure described herein is capable of numerous rearrangements, modifications and substitutions without departing from the scope of the claims hereafter. The terms “includes,” “including,” and “include” are inclusive and have the same scope as “comprises,” “comprising,” and “comprise” respectively. The claims as follows are intended to include all modifications and alterations insofar as they come within the scope of the claims or the equivalent thereof.

Having thus described the invention, the following is claimed:

1. A system comprising:
a key duplication machine configured to duplicate a master key, the key duplication machine to display an indicia unique to a current key duplication process operating on the key duplication machine; and
an app operating on a mobile device, the app configured to:
capture the indicia; and
present graphical interfaces to provide step-by-step instructions to operate the key duplication machine or to program a new vehicle key.

2. The system of claim 1, further comprising a support client operating on a computing device, the support client to present a tech support interface to facilitate helping a user of the app operate the key duplication machine.

3. The system of claim 2, wherein the app includes a support interactive element to establish communication between the app and the support client.

4. The system of claim 3, wherein the communication is a voice communication.

5. The system of claim 3, wherein the communication is a voice communication and a data communication, wherein the app provides the support client data entered through the graphical interfaces to prepopulate the tech support interface.

6. The system of claim 1, wherein the graphical interfaces present audiovisual information to guide the user through the step-by-step instructions.

7. The system of claim 1, wherein at least one of the graphical interfaces is prepopulated with information based on the indicia.

8. A method comprising:
in response to an input, displaying, on a key duplication machine configured to duplicate a master key, an indicia unique a current key duplication process operating on the key duplication machine;
capturing, on an app operating on a mobile device, the indicia; and
presenting, on the app, graphical interfaces to provide step-by-step instructions to operate the key duplication machine or to program a new vehicle key.

9. The method of claim 8, further comprising presenting, a support client operating on a computing device, a tech support interface to facilitate helping a user of the app operate the key duplication machine or to program a new vehicle key.

10. The method of claim 9, further comprising providing, by the app, a support interactive element to establish communication between the app and the support client.

11. The method of claim 10, wherein the communication is a voice communication.

12. The method of claim 10, wherein the communication is a voice communication and a data communication, wherein the app provides the support client data entered through the graphical interfaces to prepopulate the tech support interface.

13. The method of claim 8, wherein presenting the graphical interfaces includes presenting audiovisual information to guide the user through the step-by-step instructions.

14. The method of claim 8, wherein at least one of the graphical interfaces is prepopulated with information based on the indicia.

15. A tangible computer readable medium comprising instruction that, when executed, cause an app operating on a mobile device to:
capture an indicia unique to a current key duplication process operating on a key duplication machine configured to duplicate a master key or to program a vehicle key, the indicia being displayed on the key duplication machine; and
present graphical interfaces to provide step-by-step instructions to operate the key duplication machine or to program the vehicle key.

16. The computer readable medium of claim 15, where in the instructions also cause the app to establish communication between the app and a remote support client.

17. The computer readable medium of claim 16, wherein the support client operates on a computing device and includes a tech support interface to facilitate helping a user of the app operate the key duplication machine.

18. The computer readable medium of claim 16, wherein the communication is a voice communication.

19. The computer readable medium of claim 16, wherein the communication is a voice communication and a data communication, wherein the instructions cause the app to provide the support client data entered through the graphical interfaces to prepopulate the tech support interface.

20. The computer readable medium of claim 16, wherein to present the graphical interfaces, the instructions cause the app to present audiovisual information to guide the user through the step-by-step instructions.

21. The computer readable medium of claim 15, wherein at least one of the graphical interfaces is prepopulated with information based on the indicia.
